(19) United States
(12) Patent Application Publication
(10) Pub. No.: US 2011/0013547 A1
(43) Pub. Date: Jan. 20, 2011

(54) METHOD OF GENERATING PREAMBLE SEQUENCE FOR WIRELESS COMMUNICATION SYSTEM AND DEVICE THEREOF

(76) Inventors: Yen-Chin Liao, Taipei City (TW); Cheng-Hsuan Wu, Taipei City (TW); Yung-Szu Tu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/836,553

(22) Filed: Jul. 14, 2010

Related U.S. Application Data
(60) Provisional application No. 61/225,931, filed on Jul. 16, 2009.

(30) Foreign Application Priority Data
Dec. 11, 2009 (TW) 098142476

(51) Int. Cl. H04W 80/00

(52) U.S. Cl. 370/310; 370/476

(57) ABSTRACT

A method of generating preamble sequence for a wireless communication system includes generating a frequency-domain preamble sequence related to a packet, transforming the frequency-domain preamble sequence into a first time-domain preamble sequence, performing a cyclic shift delaying process on the first time-domain preamble sequence for generating a second time-domain preamble sequence, and normalizing power of the first time-domain preamble sequence and the second time-domain preamble sequence for generating the first field of a preamble of the packet.

### CROSS REFERENCE TO RELATED APPLICATIONS

This application claims the benefit of U.S. Provisional Application No. 61/225,931, filed on Jul. 16, 2009 and entitled “WIRELESS TRANSMISSION METHOD AND DEVICE USING THE SAME”, the contents of which are incorporated herein.

### BACKGROUND OF THE INVENTION

1. Field of the Invention

The present invention relates to a method of generating a preamble sequence for a wireless communication system and device thereof, and more particularly, to a method of generating a preamble sequence for a very high throughput wireless communication system and device thereof.

2. Description of the Prior Art

Wireless local area network (WLAN) technology is one of popular wireless communication technologies, which is developed for military use in the beginning and in recent years, is widely implemented in consumer electronics, e.g. desktop computers, laptop computers, personal digital assistants, etc., to provide the masses with a convenient and high-speed internet communication. IEEE 802.11 is a set of standards carrying out wireless local area network created by the Institute of Electrical and Electronics Engineers, including the former IEEE 802.11a/b/g standard and the current IEEE 802.11n standard. IEEE 802.11a/g/n standard use orthogonal frequency division multiplexing (OFDM) method to realize the air interface, and different from IEEE 802.11a/g standard, IEEE 802.11n standard is further improved by adding a multiple-input multiple-output (MIMO) technique and other features that greatly enhances data rate and throughput. In addition, in IEEE 802.11n standard the channel bandwidth is doubled to 40 MHz from 20 MHz.

A transmitted packet is composed of a preamble portion in the front of the packet and a payload portion after the preamble portion, carrying data to be transmitted. Please refer to FIG. 1A, which is a diagram of an IEEE 802.11a/g packet structure according to the prior art. An IEEE 802.11a/g preamble consists of Short Training field (STF), Long Training field (LTF), and Signal field (SIG), and the field after SIG is Data field (Data) of payload. STF is used for start-of-packet detection, automatic gain control (AGC), initial frequency offset estimation, and initial time synchronization. LTF is used for further fine frequency offset estimation and time synchronization. SIG carries the data rate (which modulation and coding scheme is used) and length (amount of data) information.

Please refer to FIG. 1B, which is a diagram of an IEEE 802.11n packet structure according to the prior art. An IEEE 802.11n preamble is a mixed format preamble consisting of legacy Short Training field (L-STF), legacy Long Training field (L-LTF), legacy Signal field (L-SIG), high-throughput Signal field (HT-SIG), high-throughput Short Training field (HT-STF), and N high-throughput Long Training fields (HT-LTF). L-STF, L-LTF, and L-SIG are the same as in an IEEE 802.11a/g preamble. HT-SIG is rotated by 90 degrees relative to L-SIG, so that a receiver can distinguish an IEEE 802.11a/g packet from an IEEE 802.11n packet after HT-SIG of the packet is decoded.

Please refer to FIG. 2, which is a functional block diagram of a transmitter 20 in a 4×4 wireless communication system according to the prior art. The transmitter 20 comprises a signal transforming unit 200, cyclic shift delay (CSD) processing units CSD_1-CSD_3, guard interval (GI) processing units GI_1-GI_4, radio frequency (RF) signal processing units RF_1-RF_4, and antennas A1-A4. The signal transforming unit 200 is utilized for performing the inverse discrete Fourier transform to transform a frequency-domain sequence Sₖ into a time-domain sequence sₙ. The time-domain sequence sₙ then passes through four paths, each called a transmit chain, including a CSD processing unit CSD_x for adding a cyclic prefix in order to avoid unintentional beamforming, a GI processing unit GI_x for adding an guard interval of 32 or 64 sampling time in order to resist inter-symbol interference, and an RF signal processing unit RF_x for converting the processed time-domain preamble sequence into an RF signal, transmitted to the air by an antenna Ax.

For the achievement of a higher quality wireless LAN transmission, the IEEE committee creates an improved standard, IEEE 802.11ac, included in IEEE 802.11 VHT (Very High Throughput) standard. Compared to the channel bandwidth of 40 MHz in IEEE 802.11n standard, the channel bandwidth in IEEE 802.11ac standard is increased to 80 MHz. IEEE 802.11ac standard should not only be backward compatible to IEEE 802.11a/g/n standard but allow a receiver to distinguish which standard a received packet conforms to as soon as possible, for improving efficiency of packet processing.

### SUMMARY OF THE INVENTION

It is therefore a primary objective of the claimed invention to provide a method of generating a preamble sequence for a wireless local area network device and device thereof.

The present invention discloses a method of generating preamble sequence. The method includes generating a frequency-domain preamble sequence related to a packet, transforming the frequency-domain preamble sequence into a first time-domain preamble sequence, performing a cyclic shift delaying process on the first time-domain preamble sequence for generating a second time-domain preamble sequence, and normalizing power of the first time-domain preamble sequence and the second time-domain preamble sequence for generating the first field of a preamble of the packet.

The present invention further discloses a wireless communication device. The wireless communication device includes a sequence generating unit for generating a frequency-domain preamble sequence related to a packet, a signal transforming unit for transforming the frequency-domain preamble sequence into a first time-domain preamble sequence, a delaying processing unit for performing a cyclic shift delaying process on the first time-domain preamble sequence for generating a second time-domain preamble sequence, and a normalization operation unit for normalizing power of the first time-domain preamble sequence and the second time-domain preamble sequence, for generating the first field of a preamble of the packet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of an IEEE 802.11a/g packet structure according to the prior art.

FIG. 1B is a diagram of an IEEE 802.11n packet structure according to the prior art.

FIG. 2 is a functional block diagram of a transmitter in a 4×4 wireless communication system according to the prior art.

FIG. 3 is a diagram of a preamble for a very high throughput wireless communication system according an embodiment of the present invention.

FIG. 4 is a functional block diagram of a wireless communication device according to an embodiment of the present invention.

FIG. 5 is a diagram of an auto-correlation function of a preamble sequence generated by the wireless communication device shown in FIG. 4.

FIG. 6A and FIG. 6B are diagrams of delay-correlation functions of a preamble sequence generated by the wireless communication device shown in FIG. 4.

FIG. 7 is a flowchart of a process according to an embodiment of the present invention.

FIG. 8 is a list of the minimum values of the packet detection probability under different SNR by each 40 MHz sub-channel and each transmit chain, measured by an auto-correlation detector of a 40 MHz receiver.

FIG. 9 is a list of the minimum values of the packet detection probability under different SNR by each 40 MHz sub-channel and each transmit chain, measured by a cross-correlation detector of a 40 MHz receiver.

FIG. 10 is a list of the minimum values of the packet detection probability under different SNR by each transmit chain, measured by an auto-correlation detector of an 80 MHz receiver.

FIG. 11 is a list of the minimum values of the packet detection probability under different SNR by each transmit chain, measured by a cross-correlation detector of an 80 MHz receiver.

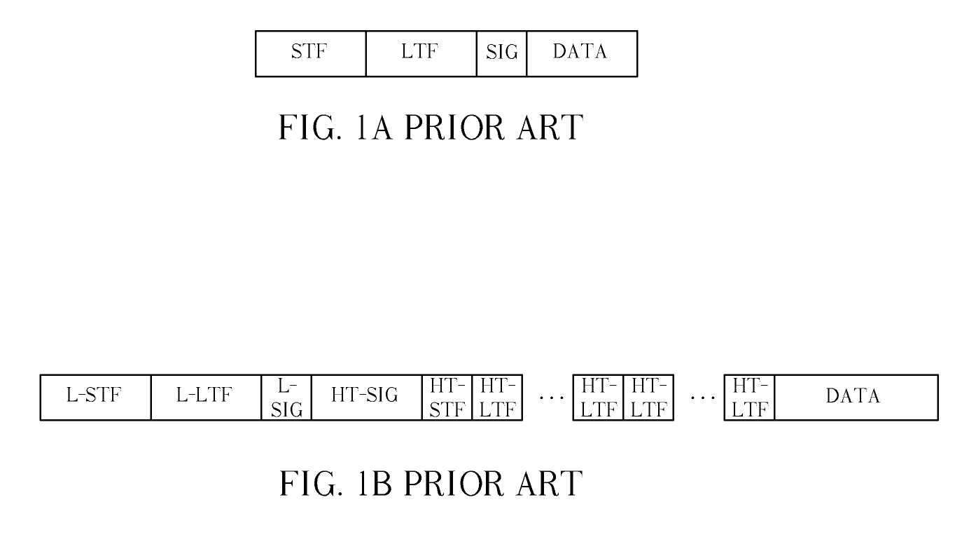

### DETAILED DESCRIPTION

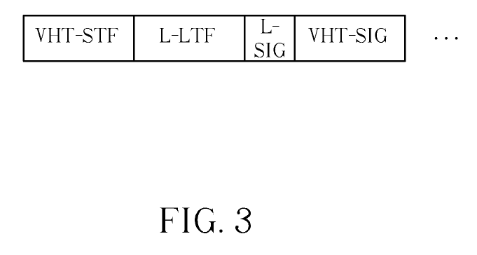

Please refer to FIG. 3, which is a diagram of a preamble for a very high throughput (VHT) wireless communication system, such as an IEEE 802.11ac wireless local area network (WLAN) system, according an embodiment of the present invention. The first field of the preamble shown in FIG. 3 is very high throughput Short Training field (VHT-STF), which is different from the first field of IEEE 802.11a/g/n preamble, legacy Short Training field (L-STF). Therefore, a transmitter according to the IEEE 802.11ac WLAN system can distinguish an IEEE 802.11ac preamble from an IEEE 802.11a/g/n preamble at the same time as the preamble is detected. By using the preamble of FIG. 3, a received packet is distinguished after the first field of a preamble of the received packet is decoded, whereas by using a preamble conforming to IEEE 802.11n standard, a received packet is distinguished until very high throughput SIGNAL field (VHT-SIG), which is much later than the first field, is decoded. Therefore, the preamble of FIG. 3 greatly improves efficiency of packet processing. As shown in FIG. 3, legacy Long Training field (L-LTF) and legacy Signal field (L-SIG), which are the same as in an IEEE 802.11a/g/n preamble, are later than VHT-STF, and very high throughput Signal field (VHT-SIG) carrying the data rate is after L-SIG, and fields after VHT-SIG are omitted in FIG. 3.

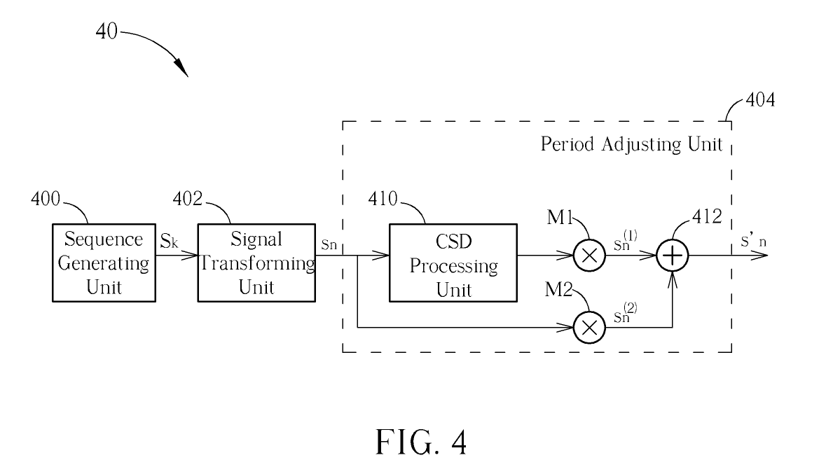

Please refer to FIG. 4, which is a functional block diagram of a wireless communication device 40 according to an embodiment of the present invention. The wireless communication device 40 is utilized in a very high throughput communication system as IEEE 802.11ac WLAN system, for generating the first field, VHT-STF, of the IEEE 802.11ac preamble as shown in FIG. 3. Note that the frequency-domain or time-domain preamble sequence mentioned in the below descriptions indicates VHT-STF shown in FIG. 3. The wireless communication device 40 comprises a sequence generating unit 400, a signal transforming unit 402, and a period adjusting unit 404. The period adjusting unit 404 comprises a cyclic shit delay (CSD) processing unit 410, multipliers M1 and M2, and an adder 412.

The sequence generating unit 400 is utilized for generating 80 MHz frequency-domain preamble sequence, hereafter called 80 MHz preamble sequence in short. In detail, the sequence generating unit 400 takes an IEEE 802.11a/g 20 MHz preamble sequence as the lowest 20 MHz portion of an 80 MHz preamble sequence, and makes replicas of the lowest 20 MHz portion to form the higher three 20 MHz portions of the 80 MHz preamble sequence, such that the 80 MHz preamble sequence can be correctly distinguished by an IEEE 802.11a/g/n receiver. Let the IEEE 802.11a/g 20 MHz preamble sequence is represented by {Sₖ: k=0, 1, . . . , 63}, and the 80 MHz preamble sequence generated by the sequence generating unit 400 is represented by {Sₖ=S_{k mod 64}, k=0, 1, . . . , 255}. The signal transforming unit 402 is coupled between the sequence generating unit 400 and the period adjusting unit 404, and is utilized for performing a 256-point inverse discrete Fourier transform, which is similar to the signal transforming unit 200 of the transmitter 20 does, to transform the 80 MHz preamble sequence Sₖ into a time-domain preamble sequence sₙ with a period of length 64 sampling points that is outputted to the period adjusting unit 404. The time-domain preamble sequence sₙ are called the preamble sequence sₙ in short.

In the period adjusting unit 404, the CSD processing unit 410 is coupled to the signal transforming unit 402; the multiplier M1 is coupled to the CSD processing unit 410; the multiplier M2 is coupled to the signal transforming unit 402; and the adder 412 is coupled to the multipliers M1 and M2. As can be seen in FIG. 4, the preamble sequence sₙ is processed by two paths. For the upper path, the CSD processing unit 410 applies a cyclic shift delay of ½ period to the preamble sequence sₙ to generate a delayed preamble sequence outputted to the multiplier M1. For the lower path, there is no CSD processing unit, and the preamble sequence sₙ is directly outputted to the multiplier M2.

The multipliers M1, M2, and the adder 412 compose a normalization operation unit for normalizing power of the preamble sequence sₙ and the delayed preamble sequence outputted by the CSD processing unit 410 in order to keep the transmit power the same. The multiplier M1 multiplies the delayed preamble sequence outputted by the CSD processing unit 410 by a normalization factor α, to generate a preamble sequence sₙ⁽¹⁾. The multiplier M2 multiplies the preamble sequence sₙ by a normalization factor \sqrt{1−α²}, to generate a preamble sequence sₙ⁽²⁾. The adder 412 adds the preamble sequences sₙ⁽¹⁾ and sₙ⁽²⁾ to form a preamble sequence s′ₙ (equal to sₙ⁽¹⁾+sₙ⁽²⁾), which is the first field of the preamble, VHT-STF, as shown in FIG. 3. Through the period adjusting unit 404, the period of VHT-STF is the length of 32 sampling points, which is a half of the period of the preamble sequence sₙ generated by the signal transforming unit 402.

Please note that, Short Training field (STF) of an IEEE 802.11a/g preamble, whose period is the length of 16 sampling points, or legacy Short Training field (L-STF) of an IEEE 802.11n preamble, whose period is the length of 32 sampling points, is over-sampled to be a sequence of a period of length 64 sampling points by an IEEE 802.11ac receiver. By measuring whether the period of the first field of a preamble of a received packet is the length of 32 or 64 sampling points, the IEEE 802.11ac receiver therefore knows that a received packet conforms to IEEE 802.11ac standard or IEEE 802.11a/g/n standard. That is, if the period of the first field of the preamble of the received packet is the length of 32 sampling points, the received packet is an IEEE 802.11ac packet; if the period of the first field of the preamble of the received packet is the length of 64 sampling points, the received packet is an IEEE 802.11a/g/n packet. In the prior art, an IEEE 802.11n receiver cannot know which standard a received packet conforms to until HT-SIG of a preamble of the received packet is decoded. In comparison, an IEEE 802.11ac transmitter using the wireless communication device 40 can generate a preamble that makes the received packet be distinguished at the same time as the fist field of the received preamble is decoded, which greatly improves efficiency of packet processing.

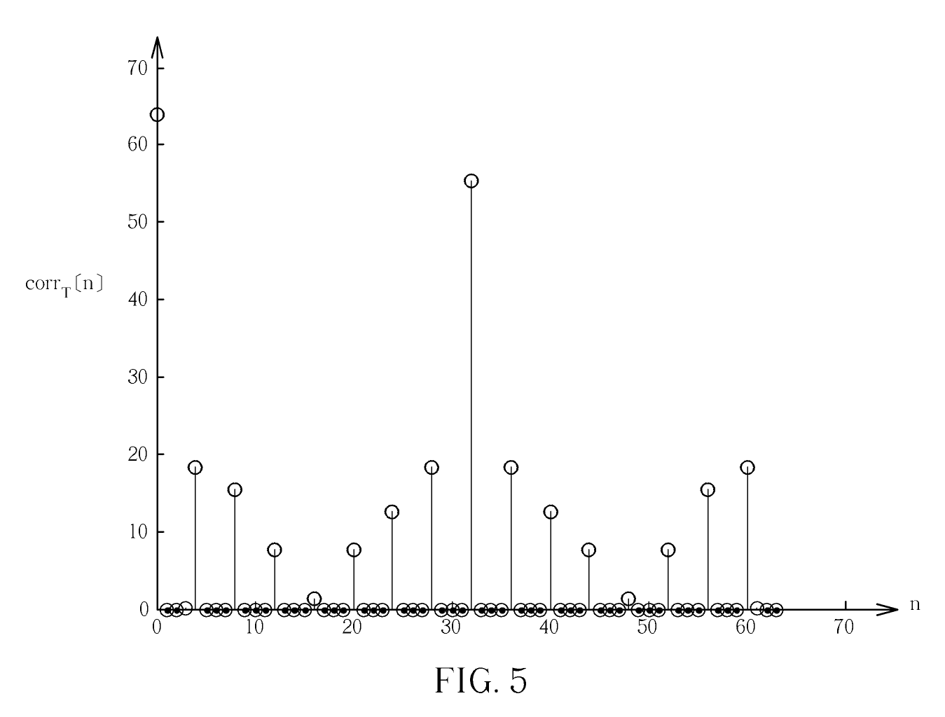

An exemplary method for distinguishing packets used in the IEEE 802.11ac receiver is described as follows. Let VHT_STF [k] represents the preamble sequence s′ₙ generated by the wireless communication device 40, and the auto-correlation function of VHT_STF [k] is

$${corr}_{T} [ n ] = {\sum }_{k = 0}^{T - 1} VHT\_STF [ n + k ] \cdot {VHT\_STF [ k ]}^{*} , \qquad ( 1 )$$

where n and k are variables, and T is the number of sampling points. Since the period of VHT_STF [k] is the length of 32 sampling points, a peak value of the auto-correlation function corr_{T} [n] appears when n is equal to a multiple of 32. Please refer to FIG. 5, which is a diagram of the auto-correlation function corr_{T} [n] of VHT_STF [k] by the normalization factor α=0.5 and T=64. As shown in FIG. 5, peak values of the auto-correlation function corr_{T} [n] show at n=0 and n=32.

As to the IEEE 802.11ac receiver, the preamble sequence VHT_STF [k] is already known. The cross-correlation function of VHT_STF [k] and a preamble sequence r [k] actually received by the IEEE 802.11ac receiver is

$${corr}_{R} [ n ] = {\sum }_{k = 0}^{T - 1} r [ n + k ] \cdot {VHT\_STF [ k ]}^{*} . \qquad ( 2 )$$

A cross-correlation detector of the IEEE 802.11ac receiver can be used to calculate the cross-correlation function corr_{R}[n] of the equation 2, by T=64. When the cross-correlation detector detects peaks every 32 sampling points, in other words, peak values of the cross-correlation function corr_{R}[n] appear every 32 sampling points, it is therefore known that the received preamble sequence r[k] is VHT-STF of an IEEE 802.11ac preamble, and thus the received packet is an IEEE 802.11ac packet. On the other hand, when the cross-correlation detector detects peaks every 64 sampling points instead of every 32 sampling points, it is known that the received preamble sequence r[k] is L-STF of an IEEE 802.11a/g/n preamble, and thus the received packet is an IEEE 802.11a/g/n packet.

In a word, the cross-correlation detector calculates the cross-correlation function corr_{R}[n] of the equation 2 by T=64, and the received packet is an IEEE 802.11ac packet or an IEEE 802.11a/g/n packet is therefore detected by positions where peak values of the cross-correlation function corr_{R}[n] appear.

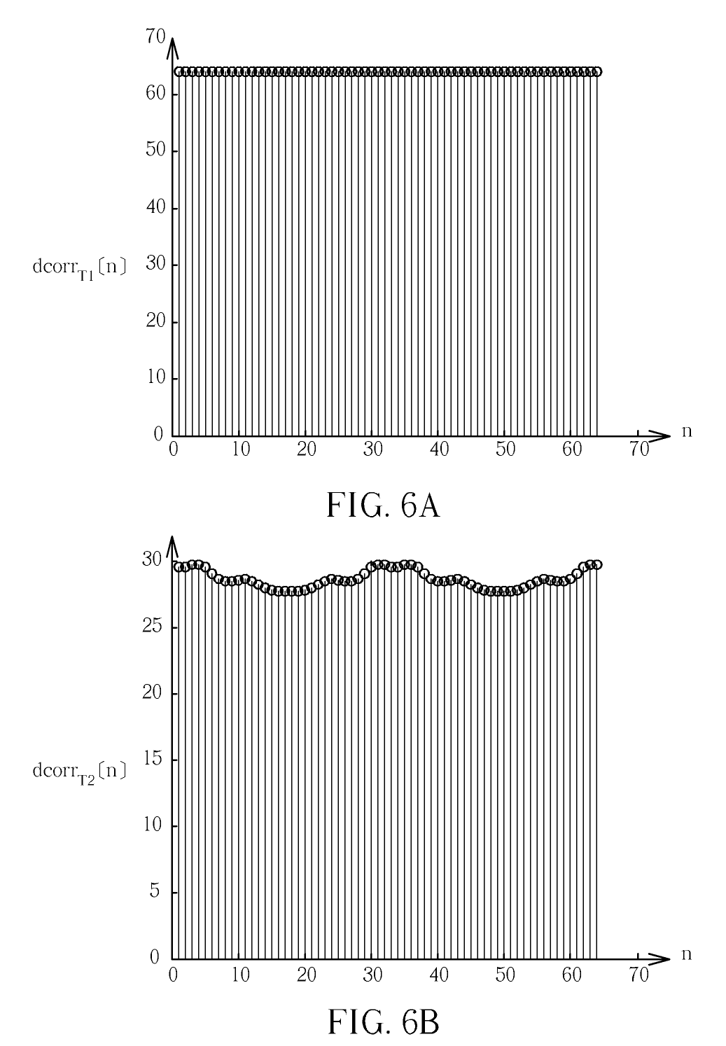

Except using the cross-correlation detector, the IEEE 802.11ac receiver can also use auto-correlation detectors to distinguish the received packet. Please refer to equation 3 and equation 4 as follows. The equation 3 illustrates a delay-correlation function dcorr_{T1}[n] with a time delay T, and the equation 4 illustrates a delay-correlation function dcorr_{T2}[n] with a time delay T/2:

$$\begin{matrix}d {corr}_{T 1} [ n ] = {\sum }_{k = 0}^{T - 1} VHT\_STF [ n + k ] \cdot {VHT\_STF [ n + k + T ]}^{*} , & ( 3 ) \\ d {corr}_{T 2} [ n ] = {\sum }_{k = 0}^{\frac{T}{2} - 1} VHT\_STF [ n + k ] \cdot {VHT\_STF [ n + k + \frac{T}{2} ]}^{*} , & ( 4 )\end{matrix}$$

where n and k are variables, and T is the number of sampling points. Please refer to FIG. 6A and FIG. 6B. FIG. 6A is a diagram of the delay-correlation function dcorr_{T1}[n] of VHT_STF [k] by the normalization factor α=0.5 and T=64; FIG. 6B is a diagram of the delay-correlation function dcorr_{T2}[n] of VHT_STF [k] by the normalization factor α=0.5 and T=64. As can be seen in FIG. 6A and FIG. 6B,

dcorr_{T1}[n]=64, and

dcorr_{T2}[n]˜30(˜T/2)>>0.

Note that when the normalization factor α is not equal to 0.5, the value of the delay-correlation function dcorr_{T1} [n] by T=64 is still equal to 64; however, the value of the delay-correlation function dcorr_{T2}[n] may be different from that shown in FIG. 6B.

As to the IEEE 802.11ac receiver, the delay-correlation functions of the received preamble sequence r [k] with time delays T and T/2 are respectively represented as

$$\begin{matrix}d {corr}_{R 1} [ n ] = {\sum }_{k = 0}^{T - 1} r [ n + k ] \cdot {r [ n + k + T ]}^{*} , and & ( 5 ) \\ d {corr}_{R 2} [ n ] = {\sum }_{k = 0}^{\frac{T}{2} - 1} r [ n + k ] \cdot {r [ n + k + \frac{T}{2} ]}^{*} . & ( 6 )\end{matrix}$$

Due to transmission error, the received preamble sequence r [k] may not be equal to the transmitted preamble sequence VHT_STF [k]. Auto-correlation detectors of the IEEE 802.11ac receiver can be used to calculate the delay-correlation functions dcorr_{R1} [n] of the equation 5 and the delay-correlation functions dcorr_{R2}[n] of the equation 6, by T=64. When the value of the delay-correlation function dcorr_{R1} [n] approaches 64 and the value of the delay-correlation function dcorr_{R2} [n] approaches 30 (which is far large than 0), it is known that the received preamble sequence r [k] is VHT-STF of an IEEE 802.11ac preamble, and thus the received packet is an IEEE 802.11ac packet. On the other hand, when the value of dcorr_{R1} [n] approaches 64 but the value of dcorr_{R2}[n] approaches 0, it is known that the received preamble sequence r [k] is L-STF of an IEEE 802.11a/g/n preamble, and thus the received packet is an IEEE 802.11a/g/n packet.

In a word, when an IEEE 802.11ac transmitter uses the wireless communication device 40 of FIG. 4 to generate the first field of the IEEE 802.11ac preamble, an IEEE 802.11ac receiver can recognize that the period of the first field of the received preamble is different from that of an IEEE 802.11a/g/n preamble after the first field of the received preamble is decoded, and determine that the received packet is an IEEE 802.11ac packet. Therefore, efficiency of packet processing is improved. Please note that the above-mentioned embodiment is illustrated by IEEE 802.11ac standard; in practice, the abovementioned embodiment are not limited to be used in the IEEE 802.11ac WLAN system and may be used in any similar wireless communication system, which can be easily derived by those skilled in the art.

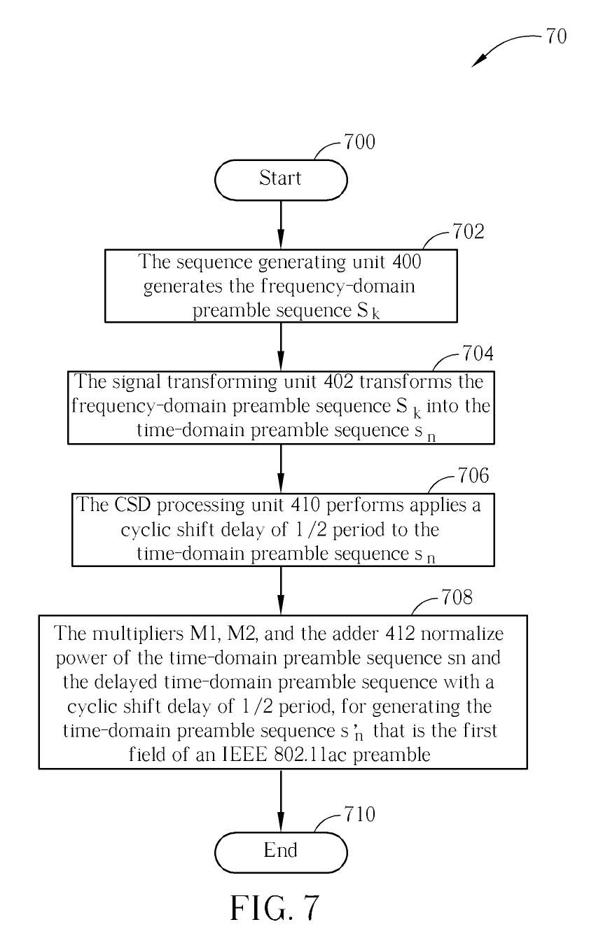

Please refer to FIG. 7, which is a flowchart of a process 70 according to an embodiment of the present invention. The process 70 is operated by the wireless communication device 40 of FIG. 4 in order to generate the first field of the IEEE 802.11ac preamble. The process 70 comprises the following steps:

Step 700: Start.

Step 702: The sequence generating unit 400 generates the frequency-domain preamble sequence Sₖ.

Step 704: The signal transforming unit 402 transforms the frequency-domain preamble sequence Sₖ into the time-domain preamble sequence sₙ.

Step 706: The CSD processing unit 410 performs applies a cyclic shift delay of ½ period to the time-domain preamble sequence sₙ.

Step 708: The multipliers M1, M2, and the adder 412 normalize power of the time-domain preamble sequence sₙ and the delayed time-domain preamble sequence with a cyclic shift delay of ½ period, for generating the time-domain preamble sequence s′ₙ that is the first field of an IEEE 802.11ac preamble.

Step 710: End.

Step 706 and Step 708 illustrate operations of the period adjusting unit 404. Since the period of the first field of the received preamble is the length of 32 sampling points, a receiver can distinguish which standard the received packet conforms to after the first field of the preamble of the received packet is decoded. Please refer to the abovementioned wireless communication device 40 to realize the process 70 in detail, which are not repeated herein.

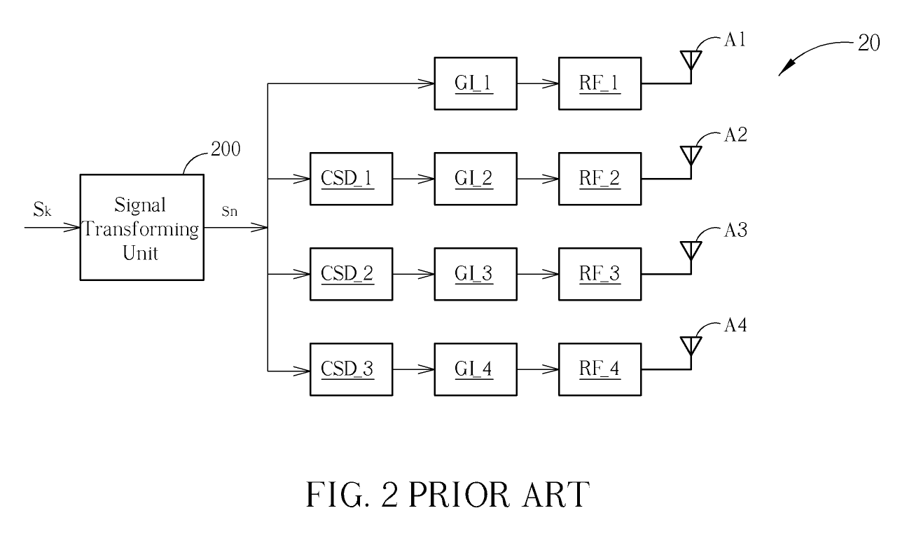

Note that, the period of fields other than the first field of a preamble is not necessary to be decreased. An IEEE 802.11ac packet is transmitted through transmit chains of the IEEE 802.11ac transmitter, similar to that shown in FIG. 2.

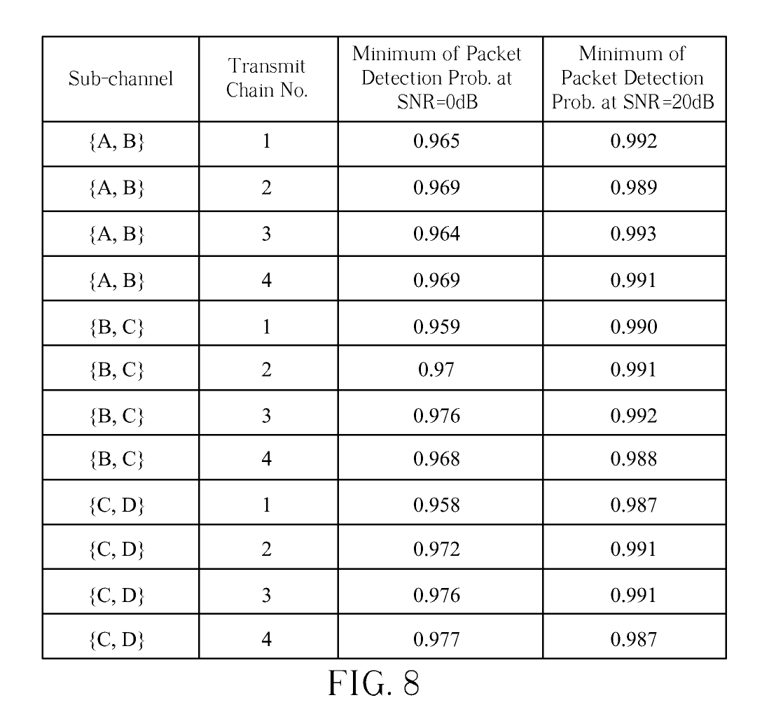

In order to verify whether receivers in the WLAN system are capable of correctly detecting the preamble according to the present invention, a simulation is performed based on a channel model B of IEEE 802.11n standard. An IEEE 802.11 ac transmitter transmits 1000 packets only including the preamble according to the present invention, and a 40 MHz receiver and an 80 MHz receiver receive the 1000 packets and calculate packet detection probability respectively, as listed in FIG. 8 to FIG. 11. Note that the 80 MHz channel can be divided into four non-overlapping 20 MHz sub-channels, denoted as A, B, C, and D from the lowest to the highest, and the 80 MHz channel can also be divided into three partially overlapping 40 MHz sub-channels {A, B}, {B, C}, and {C, D}.

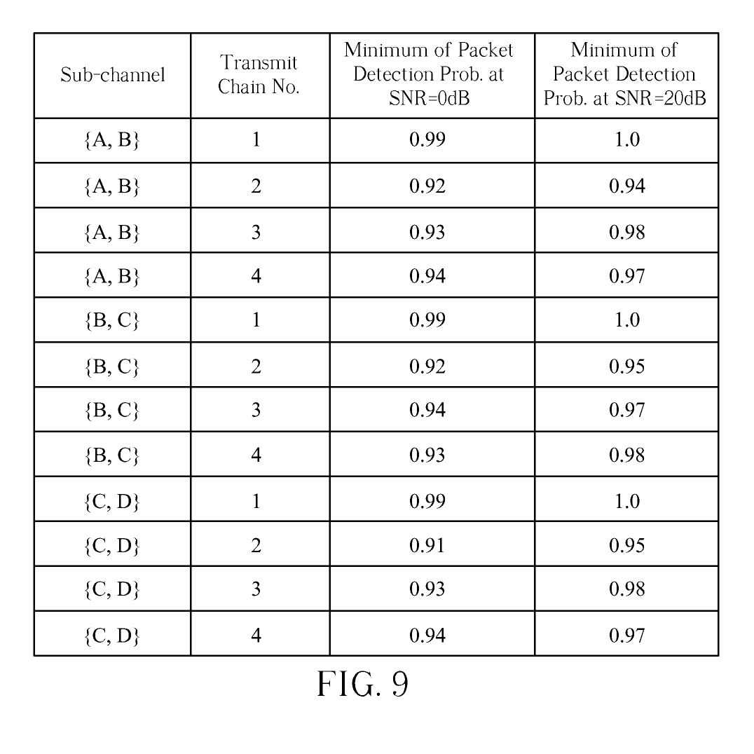

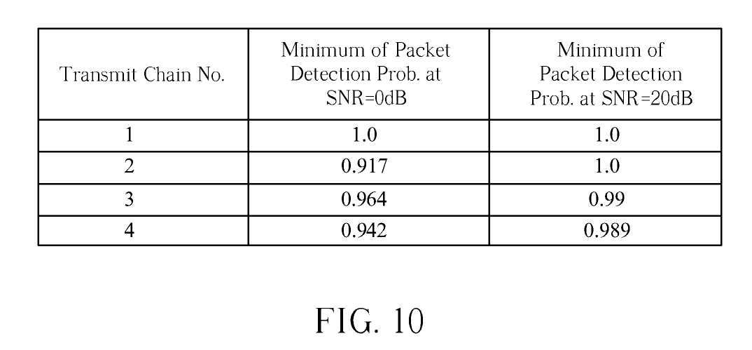

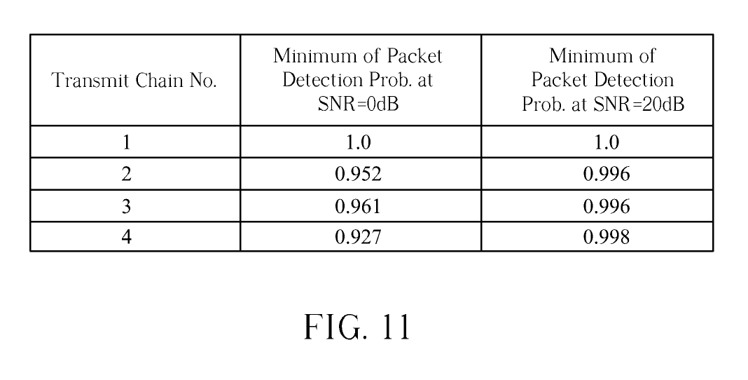

Please refer to FIG. 8. In FIG. 8, the minimum values of the packet detection probability under different signal-to-noise ratio (SNR) by 40 MHz sub-channels {A, B}, {B, C}, {C, D}, and each transmit chain, measured by an auto-correlation detector of a 40 MHz receiver, are listed. Please refer to FIG. 9. In FIG. 9, the minimum values of the packet detection probability under different SNR by 40 MHz sub-channels {A, B}, {B, C}, {C, D} and each transmit chain, measured by a cross-correlation detector of a 40 MHz receiver, are listed. It can be seen from FIG. 8 and FIG. 9 that most of the minimum values of the packet detection probability measured by the 40 MHz receiver are larger than 90%, which indicates that even the 40 MHz receiver does not support IEEE 802.11ac standard, the 40 MHz receiver can still successfully detect the 80 MHz preamble sequence generated according the present invention. Please refer to FIG. 10. In FIG. 10, the minimum values of the packet detection probability under different SNR by each transmit chain, measured by an auto-correlation detector of an 80 MHz receiver, are listed. Please refer to FIG. 11. In FIG. 11, the minimum values of the packet detection probability under different SNR by each transmit chain, measured by a cross-correlation detector of an 80 MHz receiver, are listed. It can be seen from FIG. 10 and FIG. 11 that most of the minimum values of the packet detection probability measured by the 80 MHz receiver reach up to 100%, which indicates that the 80 MHz preamble sequence generated according to the present invention can be successfully detected by the 80 MHz receiver.

In conclusion, when the transmitter in the very high throughput communication system takes the abovementioned VHT-STF as the first field of a preamble of a transmitted packet, a receiver can rapidly distinguish which standard a received packet conforms to after the first field of the received preamble is decoded. Therefore, the present invention improves efficiency of packet processing of the very high throughput communication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of generating a preamble sequence comprising:
generating a frequency-domain preamble sequence related to a packet;
transforming the frequency-domain preamble sequence into a first time-domain preamble sequence;
performing a cyclic shift delaying process on the first time-domain preamble sequence for generating a second time-domain preamble sequence; and
normalizing power of the first time-domain preamble sequence and the second time-domain preamble sequence, for generating the first field of a preamble of the packet.

2. The method of claim 1, wherein the step of performing the cyclic shift delaying process on the first time-domain preamble sequence is applying a cyclic shift delay of ½ period to the first time-domain preamble sequence, for generating the second time-domain preamble sequence.

3. The method of claim 1, wherein the step of normalizing power of the first time-domain preamble sequence and the second time-domain preamble sequence comprises:
multiplying the first time-domain preamble sequence by a first factor for generating a third time-domain preamble sequence;
multiplying the second time-domain preamble sequence by a second factor for generating a fourth time-domain preamble sequence; and
adding the third time-domain preamble sequence and the fourth time-domain preamble sequence for generating the first field of the preamble.

4. A wireless communication device comprising:
a sequence generating unit for generating a frequency-domain preamble sequence related to a packet;
a signal transforming unit for transforming the frequency-domain preamble sequence into a first time-domain preamble sequence;
a delaying processing unit for performing a cyclic shift delaying process on the first time-domain preamble sequence for generating a second time-domain preamble sequence; and
a normalization operation unit for normalizing power of the first time-domain preamble sequence and the second time-domain preamble sequence, for generating the first field of a preamble of the packet.

5. The wireless communication device of claim 4, wherein the delaying processing unit applies a cyclic shift delay of ½ period to the first time-domain preamble sequence, for generating the second time-domain preamble sequence.

6. The wireless communication device of claim 4, wherein the normalization operation unit comprises:
a first multiplier for multiplying the first time-domain preamble sequence by a first factor, for generating a third time-domain preamble sequence;
a second multiplier for multiplying the second time-domain preamble sequence by a second factor, for generating a fourth time-domain preamble sequence; and
an adder for adding the third time-domain preamble sequence and the fourth time-domain preamble sequence, for generating the first field of the preamble.
